(19) United States
(12) Patent Application Publication
(10) Pub. No.: US 2018/0226667 A1
(43) Pub. Date: Aug. 9, 2018

(54) METHOD FOR OPERATING A FUEL CELL SYSTEM AND ADJUSTING A RELATIVE HUMIDITY OF A CATHODE OPERATING GAS DURING A HEATING PHASE

(71) Applicants: VOLKSWAGEN AG, Wolfsburg (DE); AUDI AG, lngolstadt (DE)

(72) Inventor: Nadine Grünheid, Wolfsburg (DE)

(21) Appl. No.: 15/889,911

(22) Filed: Feb. 6, 2018

(30) Foreign Application Priority Data
Feb. 7, 2017 (DE) 10 2017 102 354.2

(51) Int. Cl. H01M 8/04828; H01M 8/1018; H01M 8/04007; H01M 8/04119; H01M 8/0432; H01M 8/04701

(52) U.S. Cl. CPC H01M 8/04835; H01M 8/1018; H01M 8/04067; H01M 2250/20; H01M 8/04335; H01M 8/04708; H01M 2008/1095; H01M 8/04149

(57) ABSTRACT

The invention relates to a method for operating a fuel cell system during a heating phase or another transient operating phase or a method for adjusting a relative humidity of a cathode operating gas. The fuel cell system comprises a fuel cell stack with anode and cathode chambers separated by polymer electrolyte membranes, and a cathode supply for supplying and discharging the cathode operating gas into and out of the cathode chambers, as well as a cooling system for controlling the temperature of the fuel cell stack. The method has the following steps:
determining an inlet temperature of the cathode operating gas at the inlet of the fuel cell stack,
setting a coolant setpoint temperature at the inlet of the fuel cell stack to a value which is equal to or less by a predetermined amount than the inlet temperature of the cathode operating gas, and
controlling the cooling system so that a coolant temperature prevailing at the inlet of the fuel cell stack at least approximates the coolant setpoint temperature.

### BACKGROUND

### Technical Field

The invention relates to a method for operating a fuel cell system during a heating phase or another transient operating phase of a fuel cell system. The invention further relates to a method for adjusting a relative humidity of a cathode operating gas during a heating phase or another transient operating phase. The invention furthermore relates to a fuel cell system configured for carrying out the method and to a corresponding vehicle.

### Description of the Related Art

Fuel cells use the chemical conversion of a fuel with oxygen into water in order to generate electrical energy. For this purpose, fuel cells contain the so-called membrane electrode assembly (MEA) as a core component, which is an arrangement of an ion-conducting (usually proton-conducting) membrane and of a catalytic electrode (anode and cathode), respectively arranged on both sides of the membrane. The electrodes generally comprise supported precious metals, in particular platinum. In addition, gas diffusion layers (GDL) can be arranged on both sides of the membrane electrode assembly, on the sides of the electrodes facing away from the membrane. Generally, the fuel cell is formed by a plurality of MEAs arranged in the stack, the electrical power outputs of which MEAs add up. Bipolar plates (also called flow field plates or separator plates), which ensure a supply of the individual cells with the operating media, i.e., the reactants, and which are usually also used for cooling, are generally arranged between the individual membrane electrode assemblies. In addition, the bipolar plates also ensure an electrically conductive contact to the membrane electrode assemblies.

During operation of the fuel cell, the fuel (anode operating medium), particularly hydrogen H₂ or a gas mixture containing hydrogen, is supplied to the anode via an open flow field of the bipolar plate on the anode side, where electrochemical oxidation of H₂ to protons H⁺ with loss of electrons takes place (H₂→2 H⁺+2 e⁻). A (water-bound or water-free) transport of the protons from the anode chamber into the cathode chamber is effected via the electrolyte or the membrane, which separates the reaction spaces from each other in a gas-tight manner and electrically insulates them. The electrons provided at the anode are guided to the cathode via an electrical line. The cathode receives, as cathode operating medium, oxygen or a gas mixture containing oxygen (such as air) via an open flow field of the bipolar plate on the cathode side so that a reduction of O₂ to O²⁻ with gain of electrons takes place (½ O₂+2 e⁻→O²⁻). At the same time, the oxygen anions react in the cathode chamber with the protons transported across the membrane to form water (O²⁻+2 H⁺→H₂O).

Polymer electrolyte membranes of fuel cells require some moisture to provide good ionic conductivity and hence high power density to the fuel cell. There is also the risk of damage to the membrane if it dries out too much. In order to keep the membrane moist, the cathode operating gas, mostly air, is actively humidified. Widely used for this purpose is the use of humidifiers, in particular membrane humidifiers, which work with steam-permeable flat or hollow-fiber membranes. In doing so, the cathode operating gas to be humidified is guided on one side of the membrane and a relatively moist gas is guided on the other side of the membrane so that water vapor passes from the moister gas to the cathode operating gas. As the moist gas, the cathode exhaust gas is mostly used, which is loaded with the product water formed as a result of the reactions taking place in the fuel cell.

DE 10 2007 026 331 A1 discloses a control system for a fuel cell stack in which the cathode exhaust gas is passed through a humidifier to humidify the cathode inlet air. For example, to keep the relative humidity of the cathode inlet air above a predetermined setpoint, the stack cooling fluid temperature is reduced.

DE 10 2006 022 863 A1 discloses an operating strategy for controlling a degree of hydration of membranes in fuel cells. For this purpose, a relative inlet and outlet target humidity for the cathode gas supplied to and removed from the fuel cell stack is first of all selected such that a desired hydration state is ensured for the membrane. Furthermore, a water mass balance is carried out for the cathode flow path. Subsequently, the inlet and outlet setpoint temperatures for the cathode gas are determined in order to achieve the relative inlet and outlet target humidity. In order to adjust the determined inlet and outlet setpoint temperatures for the cathode gas, the inlet and outlet setpoint temperatures for the coolant are set to the appropriate setpoints for the cathode gas and these coolant setpoint temperatures are adjusted by appropriate control of the coolant system.

### BRIEF SUMMARY

A difficulty in adjusting a desired relative humidity of the cathode operating gas is in the warm-up phases of the fuel cell stack when the ambient air drawn in as the cathode operating gas is cold and the cold line system, due to its thermal inertia, also does not permit rapid heating of the cathode operating gas. The present inventor has found that in such situations, the adjusting of a desired humidity of the cathode operating gas is only possible very imprecisely and the target humidity in the stack is often not reached.

The invention is based on the object of providing a method for operating a fuel cell system and a corresponding fuel cell system, which permits improved accuracy of adjusting a desired relative humidity of the cathode operating gas in warm-up phases or other transition phases.

This object is achieved by a method for operating a fuel cell system during a heating phase or during another transient operating phase, by a method for adjusting a relative humidity of a cathode operating gas during a heating phase or another transient operating phase and by a corresponding fuel cell system.

The term “transient operating phase” is understood to mean any operating phase of the fuel cell system in which the fuel cell stack is outside its setpoint temperature, i.e., the cooling system is required to heat the stack from a currently prevailing stack temperature to a higher temperature or to cool it to a lower temperature.

The method according to the invention for operating a fuel cell system during a heating phase or another transient operating phase relates to a fuel cell system comprising a fuel cell stack with anode and cathode chambers separated by polymer electrolyte membranes, and a cathode supply for supplying the cathode operating gas into the cathode chambers and removing a cathode exhaust gas from the cathode chambers, and a cooling system for controlling the temperature of the fuel cell stack. The method has the following steps:

determining an inlet temperature (T_{G,actual}) of the cathode operating gas at the inlet of the fuel cell stack,

setting a coolant setpoint temperature (T_{COOL,setpoint}) at the inlet of the fuel cell stack to a value which is equal to or less by a predetermined amount than the inlet temperature (T_{G,actual}) of the cathode operating gas, and

controlling the cooling system so that a coolant temperature (T_{COOL,actual}) prevailing at the inlet of the fuel cell stack at least approximates the coolant setpoint temperature (T_{COOL,setpoint}).

According to the present invention, the coolant temperature prevailing at the inlet of the fuel cell stack (hereinafter also referred to as coolant inlet temperature or actual coolant temperature) is actively controlled during the heating phase or transient operating phase of the fuel cell stack on the basis of the inlet temperature of the cathode operating gas currently prevailing at the inlet of the fuel cell stack (hereinafter also actual cathode gas temperature). The coolant inlet temperature is thus adapted to the actual cathode gas temperature. This has the consequence that the temperature of the cathode operating gas does not change substantially over the flow fields of the cathode chambers of the fuel cell stack, which is temperature-controlled to the coolant setpoint temperature. This has the effect that the relative humidity of the cathode operating gas also does not change as a result of a temperature change, in particular does not decrease as a result of heating. Namely, the present inventor has observed that in conventionally operated fuel cells, the coolant and thus also the fuel cell stack are heated faster than the cathode operating gas during a heating phase. As a result, the temperature of the cathode operating gas rises after entering the stack, reducing the relative humidity within the cathode chambers. Consequently, a sufficient humidity of the membranes of the fuel cell stack cannot be ensured. By the method according to the invention, however, heating of the incoming cathode operating gas and the concomitant decreasing relative humidity are prevented. The method according to the invention thus enables a more reliable humidification of the membranes of the fuel cell stack during heating phases or under transient conditions.

As already mentioned, the coolant setpoint temperature at the stack inlet is set to a value that is equal to or less by predetermined amount than the actual cathode gas temperature. In order to achieve the lowest possible temperature change of the cathode operating gas within the stack, this amount is to be chosen as small as possible. In particular, the amount is at most 10 Kelvin, preferably at most 7 Kelvin and more preferably at most 5 Kelvin.

The coolant temperature (actual coolant temperature) prevailing at the inlet of the fuel cell stack may be controlled by various means in order to approximate it to the coolant setpoint temperature (and thus to the actual cathode gas temperature). In one embodiment of the method, this is done by influencing a cooling capacity of a cooler arranged in the cooling system. Depending on the design of the cooler, this can be done, for example, by influencing a speed of a fan of the cooler. Alternatively or additionally, the coolant temperature is adjusted by influencing a bypass opening of a cooler bypass line bypassing the cooler. In this way, a volume flow of the coolant flowing through the cooler or the bypass line can be regulated. Alternatively or additionally, the coolant temperature is adjusted by influencing a power of a conveyor, for example a coolant pump, of the cooling system. The aforementioned measures allow a precise and rapid adjusting of a desired target temperature of the coolant and can be used individually or in combination with each other.

Another aspect of the invention relates to a method for adjusting a relative humidity of a cathode operating gas of the fuel cell system described above during a heating phase or another transient operating phase. The method has the following steps:

determining an inlet temperature (T_{G,actual}) of the cathode operating gas at the inlet of the fuel cell stack,

setting a coolant setpoint temperature (T_{COOL,setpoint}) at the inlet of the fuel cell stack to a value which is equal to or less by a predetermined amount than the inlet temperature (T_{G,actual}) of the cathode operating gas,

controlling the cooling system so that a coolant temperature (T_{COOL,actual}) prevailing at the inlet of the fuel cell stack at least approximates the coolant setpoint temperature (T_{COOL,setpoint}),

setting a setpoint value for the relative humidity (RHₛₑₜₚₒᵢₙₜ) of the cathode operating gas at the inlet of the fuel cell stack as a function of the cathode inlet temperature (T_{G,actual}) of the cathode operating gas at the inlet of the fuel cell stack,

controlling the cathode supply so that a relative humidity (RH_{actual}) of the cathode operating gas prevailing at the inlet of the fuel cell stack at least approximates the setpoint value for the relative humidity (RHₛₑₜₚₒᵢₙₜ).

The first three steps correspond to the above-explained method for operating the fuel cell system; the explanations in this respect apply accordingly.

The method according to the invention allows a particularly precise and reliable adjustment of the relative humidity of the cathode operating gas during the heating phase or another transient operating phase of the system. The adaptation according to the invention of the coolant inlet temperature in the stack to the currently prevailing inlet temperature of the cathode operating gas prevents a temperature change of the cathode operating gas, in particular a heating. As a result, the relative humidity of the cathode operating gas adjusted at the stack inlet can also be maintained within the cathode chambers. A decrease in relative humidity within the stack due to a temperature increase of the cathode operating gas is avoided and the polymer electrolyte membrane of the fuel cell stack can be reliably humidified.

The setting of the setpoint value for the relative humidity of the cathode operating gas as a function of the cathode inlet temperature can be effected, in particular, by using characteristic diagrams which map the relative humidity as a function of the temperature. In addition, the setpoint value can be determined as a function of further parameters, in particular the pressure of the cathode operating gas at the stack inlet.

The relative humidity of the cathode operating gas depends on its pressure, its temperature, the humidity originally present in the cathode operating gas, in particular in the ambient air, and a humidity actively supplied in a humidifier. With the exception of the original humidity content, all other parameters can be influenced in order to affect the relative humidity of the cathode operating gas at the stack inlet. According to one embodiment, adjusting the relative humidity of the cathode operating gas at the inlet of the fuel cell stack is effected by influencing the cathode pressure of the cathode operating gas. The cathode pressure may be accomplished, for example, by varying a compressor power of the cathode supply, by controlling an exhaust flap in a cathode exhaust path, or by suitable control of other throttles or valves of the cathode supply.

According to further embodiments of the invention, the adjustment of the relative humidity of the cathode operating gas at the stack inlet occurs by influencing an opening of a humidifier bypass line. The proportion of the cathode operating gas or the cathode exhaust gas which bypasses a humidifier arranged in the cathode supply or flows through it can be regulated in this way. By this measure, the additional amount of water vapor introduced into the cathode operating gas is regulated.

In other embodiments of the invention, adjusting the relative humidity of the cathode operating gas at the stack inlet occurs by affecting the cathode inlet temperature of the cathode operating gas. For example, the temperature can be controlled by appropriately arranged heat exchangers or heating elements. Likewise, a heat exchange, in particular a preheating of the cathode operating gas, by the warmer cathode exhaust gas takes place in the humidifier. In this respect, by influencing the opening of the humidifier bypass line not only the supply of water vapor but also the temperature can be influenced.

All of the aforementioned measures for adjusting the relative humidity of the cathode operating gas can advantageously also be used in combination.

Another aspect of the invention relates to a fuel cell system comprising a fuel cell stack having anode and cathode chambers separated by polymer electrolyte membranes; a cathode supply for supplying the cathode operating gas into the cathode chambers and discharging a cathode exhaust gas from the cathode chambers; a cooling system for controlling the temperature of the fuel cell stack to a setpoint temperature; and a control device configured to carry out the method according to the invention for operating the fuel cell system and/or the method according to the invention for adjusting a relative humidity of the cathode operating gas.

Preferably, the cathode supply furthermore comprises a humidifier configured to be flowed through by the cathode operating gas and the cathode exhaust gas such that a water vapor transfer occurs from the cathode exhaust gas to the cathode operating gas. As a result, an active supply of water to the cathode operating gas supplied to the fuel cell stack is made possible so that high relative humidities can be adjusted.

Another aspect of the invention relates to a vehicle having a fuel cell system according to the invention. The vehicle is preferably an electric vehicle in which an electrical energy generated by the fuel cell system serves to supply an electric traction motor and/or a traction battery.

The various embodiments of the invention mentioned in this application may be combined advantageously with one another unless stated otherwise in individual cases.

### BRIEF DESCRIPTION OF THE SEVERAL VIEWS OF THE DRAWINGS

The invention is explained below in exemplary embodiments in reference to the respective drawings. The following is shown:

FIG. 1 is a block diagram of a fuel cell system according to a preferred embodiment;

FIG. 2 is a diagram with time profiles of various parameters during a heating phase of a fuel cell stack according to the prior art;

FIG. 3 is a structure of a control module for the cooler bypass valve of FIG. 1; and

FIG. 4 is a flow chart of the method according to the invention for adjusting a relative humidity of the cathode operating gas of a fuel cell system of FIG. 1.

### DETAILED DESCRIPTION

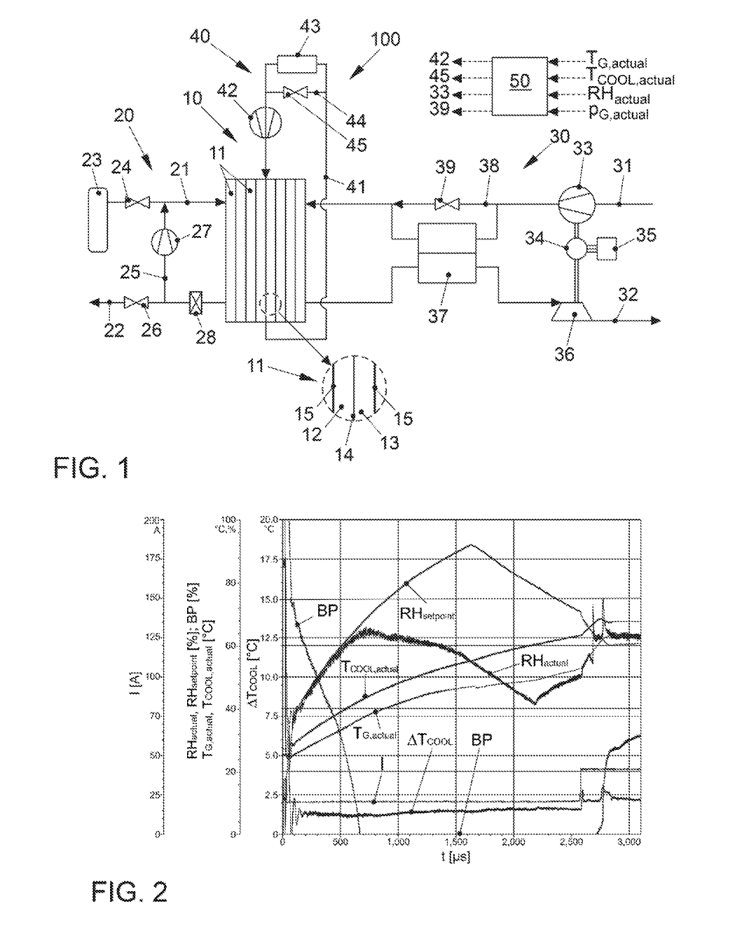

FIG. 1 shows a fuel cell system, denoted overall by 100, according to a preferred embodiment of the present invention. The fuel cell system 100 is part of a vehicle not shown in further detail, in particular of an electric vehicle, which comprises an electric traction motor, which is supplied with electrical energy by the respective fuel cell system 100.

The fuel cell system 100 comprises as core component a fuel cell stack 10, which comprises a plurality of individual cells 11, which are arranged in the form of a stack and which are formed by alternately stacked membrane electrode assemblies (MEAs) 14 and bipolar plates 15 (see detailed view). Each individual cell 11 thus comprises, in each case, an MEA 14 which has an ionically conductive polymer electrolyte membrane (not shown in detail) as well as catalytic electrodes arranged on both sides thereof, namely an anode and a cathode which catalyze the respective partial reaction of the fuel cell conversion. The anode and cathode electrodes comprise a catalytic material, for example platinum, which is supported on an electrically conductive carrier material with a large specific surface, for example a carbon-based material. An anode chamber 12 is thus formed between a bipolar plate 15 and the anode, and the cathode chamber 13 between the cathode and the next bipolar plate 15. The bipolar plates 15 serve to supply the operating media into the anode and cathode chambers 12, 13 and also establish the electrical connection between the individual fuel cells 11. Furthermore, the bipolar plates 15 serve the passage of a coolant for the fuel cell stack 10.

In order to supply the fuel cell stack 10 with the operating media, the fuel cell systems 100 comprise an anode supply 20 on the one hand and a cathode supply 30 as well as a cooling system 40 on the other hand.

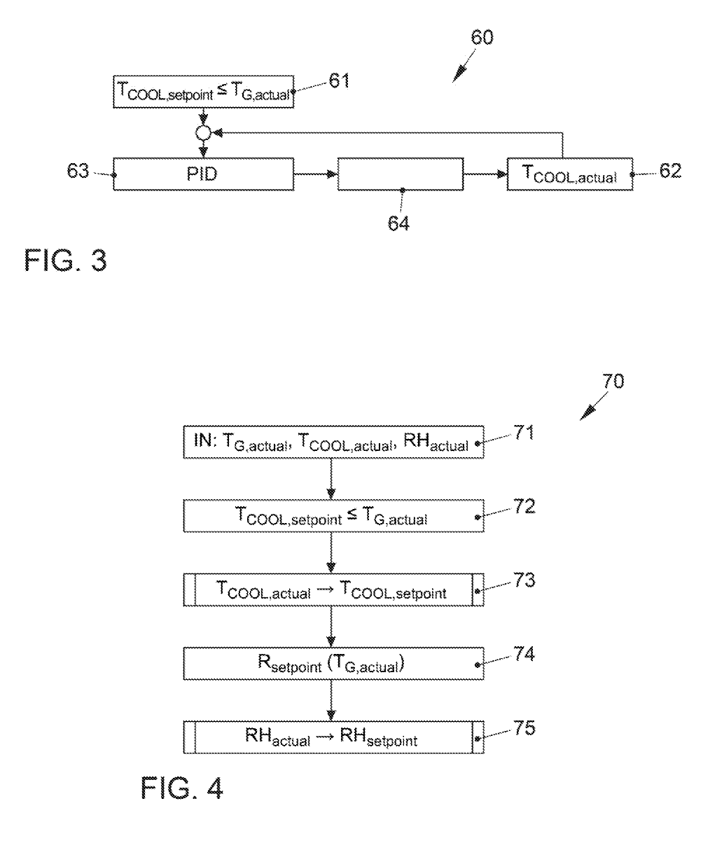

The anode supply 20 of the fuel cell system 100 shown in FIG. 1 comprises an anode supply path 21, which serves to supply an anode operating medium (the fuel), such as hydrogen, to the anode chambers 12 of the respective fuel cell stack 10. For this purpose, the anode supply paths 21 respectively connect a fuel storage tank 23 to an anode inlet of the respective fuel cell stack 10. The anode supply 20 also comprises an anode exhaust path 22 which discharges the anode exhaust gas from the anode chambers 12 via an anode outlet of the respective fuel cell stack 10. The anode operating pressure on the anode sides 12 of the respective fuel cell stack 10 can be adjusted via an initial adjusting means 24 in the anode supply path 21. In addition, the anode supply 20 of the fuel cell system shown in FIGS. 1 and 3 comprises a recirculation line 25 as shown, which connects the anode exhaust path 22 to the anode supply path 21. The recirculation of fuel is customary in order to return the mostly over-stoichiometrically supplied fuel to the stack and to use it. In the recirculation line, a recirculation conveyor 27, preferably a recirculation fan, is arranged. Furthermore, a water separator 28 is respectively installed in the anode exhaust gas path 22 in order to condense and discharge fuel cell reaction product water discharged from the fuel cell stack 10.

In the anode exhaust gas line 22 of the fuel cell system 100 shown in FIG. 1, a second adjusting means 26 is arranged downstream of the recirculation line 25. With the second adjusting means 26, a recirculation circuit can be isolated from the environment. The first and second adjusting means 24, 26 can be used together to largely prevent leakage of the anode operating medium from the anode chambers 12.

The cathode supply 30 of the fuel cell system 100 shown in FIG. 1 comprises a cathode supply path 31, which supplies an oxygen-containing cathode operating medium, in particular air taken in from the environment, to the cathode chambers 13 of the fuel cell stack 10. The cathode supply 30 also comprises a cathode exhaust path 32, which discharges the cathode exhaust gas (in particular the exhaust air) from the cathode chambers 13 of the fuel cell stack 10 and supplies it, if appropriate, to an exhaust system not shown. A compressor 33 is arranged in the cathode supply path 31 in order to convey and compress the cathode operating medium. In the exemplary embodiment shown, the compressor 33 is designed as a compressor 33 which is mainly driven by an electric motor 34 equipped with appropriate power electronics 35. The compressor 33 may also be driven via a common shaft by a turbine 36 (optionally with variable turbine geometry) disposed in the cathode exhaust path 32.

The fuel cell system 100 shown in FIG. 1 furthermore comprises a humidifier 37. On the one hand, the humidifier 37 is respectively arranged in the cathode supply path 31 in such a way that it can be flowed through by the cathode operating gas. On the other hand, the arrangement in the cathode exhaust path 32 allows the cathode exhaust gas to flow through it. The humidifier 37 typically comprises a plurality of water vapor-permeable membranes, which are designed to be either flat or in the form of hollow fibers. In this case, the comparatively dry cathode operating gas (air) flows over one side of the membranes and the comparatively moist cathode exhaust gas (exhaust gas) flows over the other side. Driven by the higher partial pressure of the water vapor in the cathode exhaust gas, water vapors pass over the membrane into the cathode operating gas, which is moistened in this way. The humidification of the cathode operating gas serves to ensure a predetermined relative humidity of the cathode operating gas to keep the polymer electrolyte membrane of the fuel cells 11 sufficiently moist so that it has a high ionic conductivity and is protected from damage.

The cathode supply 30 furthermore comprises a humidifier bypass line 38 which connects the cathode supply line 31 to the cathode supply line 31 so that the humidifier 37 upstream of the fuel cell stack 10 is not flowed through by the cathode operating gas. An adjusting means (humidifier bypass valve) 39 arranged in the humidifier bypass line 38 serves to control the amount of the cathode operating gas bypassing the humidifier 37. Alternatively or additionally, the cathode supply 30 may comprise another humidifier bypass line connecting the cathode exhaust gas line 32 to the cathode exhaust gas line 32 so that the humidifier 37 downstream of the fuel cell stack 10 is not flowed through by the cathode exhaust gas (not shown).

For cooling the fuel cell stack 10, the fuel cell system 100 shown in FIG. 1 also has a cooling system (coolant circuit) 40. This is formed outside of the respective fuel cell stack 10 by a coolant line 41 which guides a coolant and which is connected to a coolant inlet and coolant outlet of the fuel cell stack 10. In the fuel cell stack 10, coolant channels are arranged in the bipolar plates 15 between the coolant inlet and coolant outlet. For conveying the coolant through the coolant line 41 and the coolant channels of the fuel cell stack 10, a coolant conveyor 42 is arranged in the coolant circuit 40. The discharge of the waste heat, transported by the coolant, of the fuel cell stack 10 is carried out by a cooler 43, such as a vehicle radiator, to which a fan (not shown) supplies air. A cooler bypass line 44 allows the coolant to bypass the cooler 43, for example during a warm-up phase of the fuel cell stack 10 after a cold start. An amount of the coolant bypassing the cooler 43 may be regulated by another adjusting means (cooler bypass valve) 45 disposed in the cooler bypass line 44.

All adjusting means 24, 26, 39 of the fuel cell system 100 can be designed as controllable or non-controllable valves or throttles. Additional adjusting means may be arranged in the lines 21, 22, 31 and 32 in order to be able to isolate the fuel cell stack 10 from the environment after turning off the system.

The fuel cell system 100 of FIG. 1 furthermore comprises a control device 50, in which various signals of different sensors arranged in the fuel cell system and not shown here are received and which controls various components of the system by sending corresponding control signals. Thus, the fuel cell system 100 comprises various temperature sensors, in particular a temperature sensor arranged at the inlet of the cathode supply path 31 into the fuel cell stack 10 for detecting the actual value of the inlet temperature of the cathode operating gas T_{G,actual}. Furthermore, the cooling circuit 40 comprises a temperature sensor arranged at the stack inlet of the coolant line 41 for detecting the actual value of the coolant inlet temperature T_{COOL,actual}. Furthermore, downstream of the humidifier 37 and upstream of the fuel cell stack 10, a humidity sensor for detecting the relative humidity of the cathode operating gas RH_{actual} is disposed as well as a pressure sensor for detecting the pressure p_{G,actual}. The control device 50 comprises computer-readable control algorithms for operating the fuel cell system or for adjusting the relative humidity of the cathode operating gas during a heating phase or another transient operating condition depending on the aforementioned and optionally additional signals. For this purpose, the control device 50 controls in particular a delivery rate of the coolant conveyor 42, a position of the cooler bypass valve 45, a power of the compressor 33 and a position of the humidifier bypass valve 39.

If a conventional fuel cell system is operated in a conventional manner during a heating phase, the polymer electrolyte membranes of the membrane electrode assemblies 14 of the fuel cell stack 10 may be undersupplied with humidity. This will be explained with reference to the curves of various operating parameters shown in FIG. 2. In FIG. 2, RHₛₑₜₚₒᵢₙₜ and RH_{actual} denote the setpoint value and the actual value respectively of the relative humidity of the cathode operating medium at the inlet of the fuel cell stack 10. T_{G,actual} denotes the inlet temperature of the cathode operating medium at the stack inlet and T_{COOL,actual} is the inlet temperature of the coolant at the stack inlet. ΔT_{COOL} denotes the temperature difference of the coolant between the stack inlet and the stack outlet. BP indicates the position of the humidifier bypass valve 39, where a value of 100% means a full opening of the valve so that the cathode operating medium is completely directed through the humidifier bypass line 38, and 0% means a complete closure of the valve 39 so that the cathode operating medium flows completely through the humidifier 37. Finally, I denotes the electric current provided by the fuel cell stack 10. Shown are only the first 3000 μs after a cold start of a fuel cell system.

In order to achieve the setpoint value of the relative humidity RHₛₑₜₚₒᵢₙₜ, the humidifier bypass valve 39 is first completely closed in accordance with the conventional procedure according to FIG. 2 so that the cathode operating gas is guided completely through the humidifier 37 (curve BP). In order to furthermore ensure a rapid heating of the fuel cell stack 10, the cooler bypass valve 45 is fully opened in the warm-up phase shown in FIG. 2 so that the entire coolant flows through the bypass line 44 and not through the cooler 43. After the cold start, the inlet temperatures of both the coolant T_{COOL,actual} and the cathode gas T_{G,actual} are at ambient temperature. However, it can be seen that the coolant temperature is always slightly above the cathode gas temperature and moves even further away from it in the further course. The relative humidity RH_{actual} of the cathode operating medium which is actually present at the stack inlet initially follows the setpoint curve to the greatest possible extent. However, between 500 and 1000 μs, despite the complete closure of the humidifier bypass line 38, there is a marked drop in the relative humidity RH_{actual} of the cathode gas present at the stack inlet so that the setpoint humidity RHₛₑₜₚₒᵢₙₜ is clearly undershot. According to the inventor's observation, this is caused by the cathode operating gas being heated up, when entering the stack 10, by the warmer coolant so that the relative humidity decreases. Thus, the actual relative humidity of the air used here as cathode operating gas at the membrane is lower than the adjusted relative humidity at the stack inlet. Thus, a reliable humidification of the polymer electrolyte membrane cannot be ensured in the prior art. The consequence of this is that a higher relative humidity would have to be adjusted at the stack inlet in order to obtain a desired membrane moisture. This, in turn, requires greater utilization of the humidifier performance and thus also greater aging thereof or greater dimensioning. Furthermore, it is possible and customary in the prior art to define special operating conditions in which the efficiency of the fuel cell is lower than during normal operation. However, all these measures are disadvantageous and are avoided by the method according to the invention, namely by guiding the coolant inlet temperature at the inlet of the stack on the basis of the inlet temperature of the cathode operating gas during the heating phase of the fuel cell stack 10.

A corresponding control module 60 of the control unit 50 for controlling the coolant temperature of the cooling circuit 40 is shown in FIG. 3. Here, the coolant temperature is controlled by the position of the cooler bypass valve 45. In block 61, the setpoint value of the coolant inlet temperature T_{COOL,setpoint} is read out. According to the present invention, it is set so as to be substantially equal to or slightly lower than the inlet temperature T_{G,actual} of the cathode operating gas. In block 62, a measurement of the coolant temperature T_{COOL,actual} prevailing at the stack inlet takes place. There is a comparison of the actual temperature with the setpoint temperature of the coolant and an output of the comparison value to a PID controller for the cooler bypass valve 45 (block 63). Based on the comparison value, a control signal for controlling the bypass valve 45 is generated in block 64 and send thereto so that the bypass valve 45 assumes a desired position. By the feedback loop, an adjustment of the actual coolant temperature T_{COOL,actual} to the coolant setpoint temperature T_{COOL,setpoint}, and thus to the inlet temperature of the cathode operating gas T_{G,actual}, takes place.

FIG. 4 shows a rough flow diagram of a method 70 according to the invention for adjusting a relative humidity of the cathode operating gas of the fuel cell system 100 shown in FIG. 1 during a heating phase.

In block 71, the control unit 50 reads in various measurands provided by the various sensors. Specifically, the inlet temperature of the cathode operating gas T_{G,actual}, the inlet temperature of the coolant T_{COOL,actual} and the relative humidity RH_{actual} of the cathode operating gas at the stack inlet are detected. In block 72, the coolant setpoint temperature at the stack inlet is determined. In this case, the coolant setpoint temperature T_{COOL,setpoint} is set to a value which is equal to or less by a predetermined amount, for example by not more than 5 Kelvin, than the inlet temperature T_{G,actual} of the cathode operating gas at the stack inlet. In block 73, the cooling system 40 is controlled such that the coolant temperature T_{COOL,actual} prevailing at the inlet of the fuel cell stack 10 is approximating the coolant setpoint temperature T_{COOL,setpoint}. For this purpose, the control module 60, shown in FIG. 3, for the cooler bypass valve 45 can be used in particular.

In block 74, the setpoint value for the relative humidity RHₛₑₜₚₒᵢₙₜ of the cathode operating gas at the inlet of the fuel cell stack 10 is determined. This is done as a function of the cathode inlet temperature T_{G,actual} and possible further parameters, such as the pressure p_{G,actual}. In block 75, the cathode supply 30 of the fuel cell system 100 is controlled such that a relative humidity RH_{actual} of the cathode operating gas present at the inlet of the fuel cell stack 10 approximates the setpoint value RHₛₑₜₚₒᵢₙₜ. For this purpose a control module for controlling the humidifier bypass valve 39 can, for example, be used.

By means of the method 70 according to the invention as illustrated in FIG. 4, the decrease in the actual relative humidity RH_{actual} of the cathode operating gas within the fuel cell stack shown in FIG. 2 is avoided. By controlling the coolant temperature based on the temperature of the cathode operating gas (air temperature) at the stack inlet, the membrane moisture resulting from the relative humidity of the air can be adjusted such that the fuel cells 11 are less damaged and that the service life of the stack 10 increases and its efficiency is higher as a result. The invention further allows the size of the humidifier 37 to be reduced. In transient operating ranges, there is also an application of the method in order to reduce the load on the membranes in the fuel cell stack 10 and to thus increase the entire service life of the fuel cell stack 10.

German patent application no. 10 2017 102354.2, filed Feb. 7, 2017, to which this application claims priority, is hereby incorporated herein by reference.

1. A method for operating a fuel cell system during a transient operating phase, wherein the fuel cell system comprises a fuel cell stack having anode chambers and cathode chambers separated by polymer electrolyte membranes, a cathode supply for supplying a cathode operating gas into the cathode chambers and discharging a cathode exhaust gas from the cathode chambers, and a cooling system for controlling a temperature of the fuel cell stack, wherein the method comprises:
determining an inlet temperature of the cathode operating gas at an inlet of the fuel cell stack,
setting a coolant setpoint temperature at the inlet of the fuel cell stack to a value which is equal to or less by a predetermined amount than the inlet temperature of the cathode operating gas, and
controlling the cooling system so that a coolant temperature at the inlet of the fuel cell stack is substantially the same as the coolant setpoint temperature.

2. The method according to claim 1, wherein the predetermined amount is less than or equal to 10 K.

3. The method according to claim 1, wherein the coolant temperature at the inlet of the fuel cell stack is adjusted by changing a cooling capacity of a cooler of the cooling system, changing a bypass opening of a cooler bypass line of the cooler, or changing a power of a conveyor of the cooling system.

4. A method for adjusting a relative humidity of a cathode operating gas of a fuel cell system during a transient operating phase, the fuel cell system comprising a fuel cell stack having anode chambers and cathode chambers separated by polymer electrolyte membranes, a cathode supply for supplying a cathode operating gas into the cathode chambers and discharging a cathode exhaust gas from the cathode chambers, and a cooling system for controlling a temperature of the fuel cell stack, wherein the method comprises:
determining an inlet temperature of the cathode operating gas at an inlet of the fuel cell stack,
setting a coolant setpoint temperature at the inlet of the fuel cell stack to a value which is equal to or less by a predetermined amount than the inlet temperature of the cathode operating gas,
controlling the cooling system so that a coolant temperature at the inlet of the fuel cell stack is substantially the same as the coolant setpoint temperature;
setting a setpoint value for a relative humidity of the cathode operating gas at the inlet of the fuel cell stack as a function of the inlet temperature of the cathode operating gas at the inlet of the fuel cell stack, and
controlling the cathode supply so that a relative humidity of the cathode operating gas at the inlet of the fuel cell stack is substantially the same as the setpoint value for the relative humidity.

5. The method according to claim 4, wherein the relative humidity of the cathode operating gas at the inlet of the fuel cell stack is adjusted by changing a cathode pressure of the cathode operating gas.

6. The method according to claim 4, wherein the relative humidity of the cathode operating gas at the inlet of the fuel cell stack is adjusted by changing an opening of a humidifier bypass line.

7. The method according to claim 4, wherein the relative humidity of the cathode operating gas at the inlet of the fuel cell stack is adjusted by changing the inlet temperature of the cathode operating gas at the inlet of the fuel cell stack.

8. A fuel cell system, comprising:
a fuel cell stack with anode chambers and cathode chambers separated by polymer electrolyte membranes;
a cathode supply for supplying a cathode operating gas into the cathode chambers and discharging a cathode exhaust gas from the cathode chambers;
a cooling system for controlling a temperature of the fuel cell stack to a setpoint temperature; and
a control unit configured to control the fuel cell system, during a transient operating phase of the fuel cell system, to:
determine an inlet temperature of the cathode operating gas at an inlet of the fuel cell stack,
set a coolant setpoint temperature at the inlet of the fuel cell stack to a value which is equal to or less by a predetermined amount than the inlet temperature of the cathode operating gas, and
control the cooling system so that a coolant temperature at the inlet of the fuel cell stack is substantially the same as the coolant setpoint temperature.

9. The fuel cell system according to claim 8, wherein the control unit is further configured to control the fuel cell system to:
set a setpoint value for a relative humidity of the cathode operating gas at the inlet of the fuel cell stack as a function of the inlet temperature of the cathode operating gas at the inlet of the fuel cell stack, and
control the cathode supply so that a relative humidity of the cathode operating gas at the inlet of the fuel cell stack is substantially the same as the setpoint value for the relative humidity.

10. The fuel cell system according to claim 8, wherein the cathode supply includes a humidifier configured to be flowed through by the cathode operating gas and the cathode exhaust gas such that a water vapor transfer occurs from the cathode exhaust gas to the cathode operating gas.

11. The fuel cell system according to claim 8, wherein the fuel cell system is a component of a wheeled vehicle.
